(19) United States
(12) Patent Application Publication
(10) Pub. No.: US 2015/0320172 A1
(43) Pub. Date: Nov. 12, 2015

(54) RAZOR COMB HAIR TOOL

(71) Applicant: Litomi LLC, Carmel, IN (US)

(72) Inventors: Lillian Love Spencer, Indianapolis, IN (US); Thomas F. Foust, Carmel, IN (US); Garry Robin Marty, Fishers, IN (US)

(21) Appl. No.: 14/708,754

(22) Filed: May 11, 2015

Related U.S. Application Data
(60) Provisional application No. 61/990,792, filed on May 9, 2014.

(51) Int. Cl. A45D 24/36; B26B 21/12

(52) U.S. Cl. CPC A45D 24/36; B26B 21/12

(57) ABSTRACT

A razor comb hair tool includes a razor blade, a blade guard, and a retainer. The blade guard has first and second opposing edges, with the first edge of the blade guard defining a plurality of spaced apart comb teeth. The blade guard has a position in which the razor blade is retained within the blade guard and a cutting edge of the razor blade is aligned with and extends between the spaced apart comb teeth. The retainer has first and second opposing ends. The first end of the retainer releasably receives the second edge of the blade guard, and the second end of the retainer includes a plurality of curved finger receiving contours.

### RELATION TO OTHER PATENT APPLICATION

This application claims priority to U.S. provisional patent application 61/990,792, filed May 9, 2014, with the same title.

### TECHNICAL FIELD

The present disclosure relates generally to a razor comb hair tool, and more particularly to a hair tool including a razor blade and a comb portion.

### BACKGROUND

A razor comb is a hair-cutting and hair-shaping tool that typically has a handle longitudinally spaced from the razor blade and comb portion. These razor combs resemble, and are often mistaken for, conventional combs. Importantly, however, razor combs include a razor blade, often positioned such that a cutting edge of the razor blade extends between comb teeth, for creating texture in hair and/or thinning out thick, coarse hair. A portion of the razor comb, such as the comb portion, may be slid over the razor blade and/or the razor comb may include an ejector feature to release and replace the razor blade. These and other currently available means for inserting and removing razor blades are difficult, dangerous, time-consuming, and unreliable. In addition, due to the positioning of the handle relative to the razor blade, it is often difficult to get precise control and accurate lines using these conventional razor combs.

The present disclosure is directed to one or more of the problems or issues set forth above.

### SUMMARY OF THE DISCLOSURE

In one aspect, a razor comb hair tool includes a razor blade, a blade guard, and a retainer. The blade guard has first and second opposing edges, with the first edge of the blade guard defining a plurality of spaced apart comb teeth. The blade guard has a position in which the razor blade is retained within the blade guard and a cutting edge of the razor blade is aligned with and extends between the spaced apart comb teeth. The retainer has first and second opposing ends. The first end of the retainer releasably receives the second edge of the blade guard and the second end of the retainer includes a plurality of curved finger receiving contours.

In another aspect, a razor comb hair tool kit includes a razor blade, a set of blade guards, and a first retainer. Each blade guard has a first edge defining a plurality of spaced apart comb teeth, with the blade guard having a position in which the razor blade is retained within the blade guard and a cutting edge of the razor blade is aligned with and extends between the spaced apart comb teeth. A profile of the spaced apart comb teeth of each blade guard in the set is different. The first retainer has first and second opposing ends. The first end of the retainer releasably receives a second edge of one of the blade guards and the second end of the retainer includes a plurality of curved finger receiving contours.

### BRIEF DESCRIPTION OF THE DRAWINGS

FIG. 1 is a perspective view of an exemplary razor comb hair tool, according to the present disclosure;

FIG. 2 is a perspective view of a blade guard, shown in an open position, and a razor blade, both exemplary components of the razor comb hair tool of FIG. 1;

FIG. 3 is a perspective view of the blade guard of FIG. 2, shown in a closed position, with the razor blade retained within the blade guard;

FIG. 4 is a perspective view of the blade guard, shown in the closed position of FIG. 3, prior to the blade guard being releasably received within a retainer of the razor comb hair tool;

FIG. 5 is a perspective view of an another exemplary embodiment of a razor comb hair tool of the present disclosure, having a first alternative handle portion of the retainer;

FIG. 6 is a perspective view of another exemplary embodiment of a razor comb hair tool of the present disclosure, having a second alternative handle portion;

FIG. 7 is a perspective view of another exemplary embodiment of a razor comb hair tool of the present disclosure, having a third alternative handle portion;

FIG. 8 is a side view of another exemplary embodiment of a razor comb hair tool of the present disclosure, having a first alternative set of comb teeth;

FIG. 9 is a side view of another exemplary embodiment of a razor comb hair tool of the present disclosure, having a second alternative set of comb teeth; and

FIG. 10 is a side view of another exemplary embodiment of a razor comb hair tool of the present disclosure, having a third alternative set of comb teeth.

### DETAILED DESCRIPTION

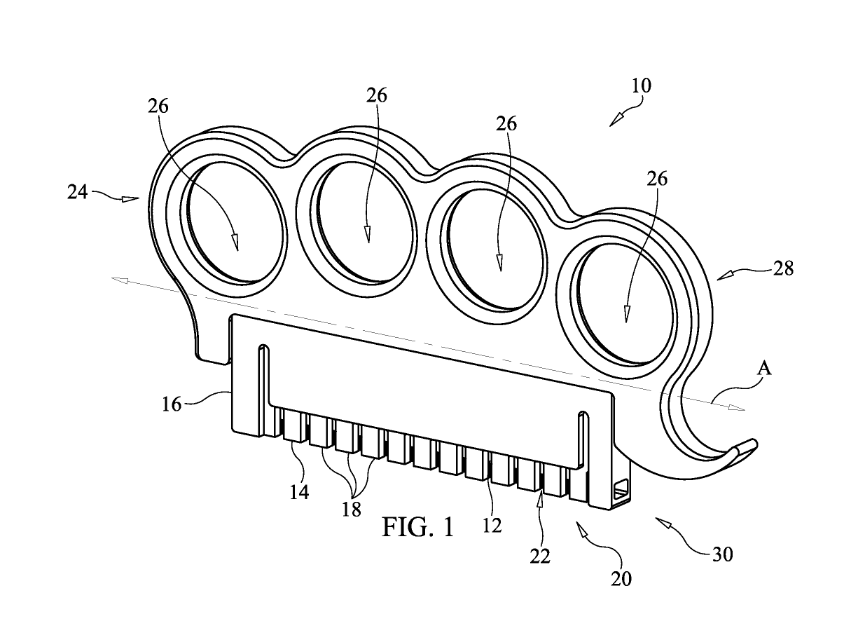

FIG. 1 illustrates an exemplary razor comb hair tool 10, according to the present disclosure. The razor comb hair tool 10 generally includes a razor blade 12, a blade guard 14, and a retainer 16, all shown in an assembled configuration. Although specific configurations are shown and described for each of the razor blade 12, blade guard 14, and retainer 16, it should be appreciated that configurations of these components, including sizes, shapes, and features, may vary without deviating from the scope of the present disclosure. For example, each of the razor blade 12, blade guard 14, and retainer 16 may be made from any known materials, selected for ease of manufacture and/or to enhance performance of the razor comb hair tool 10.

As will be described in greater detail below, the assembled configuration of the razor comb hair tool 10 includes the razor blade 12 retained within the blade guard 14, and the blade guard 14 releasably received within the retainer 16. Also in the assembled configuration, a plurality of spaced apart comb teeth 18, defined by an edge 20 of the blade guard 14, are exposed relative to the retainer 16. In addition, a cutting edge 22 of the razor blade 12 is aligned with and extends between adjacent ones of the spaced apart comb teeth 18. As shown, the cutting edge 22 may be receded relative to free tips or ends of the spaced apart comb teeth 18. In addition, the spaced apart comb teeth 18 may be evenly spaced along the edge 20 of the blade guard 14. The retainer 16 includes a handle portion 24, which includes a plurality of curved finger receiving contours 26, positioned on an opposite side 28 of the razor comb hair tool 10 relative to the spaced apart comb teeth 18 and the cutting edge 22 of the razor blade 12. That is, the handle portion 24 of the retainer 16 and the spaced apart comb teeth 18 may be positioned on opposite sides 28 and 30 of a longitudinal axis A through the razor comb hair tool 10.

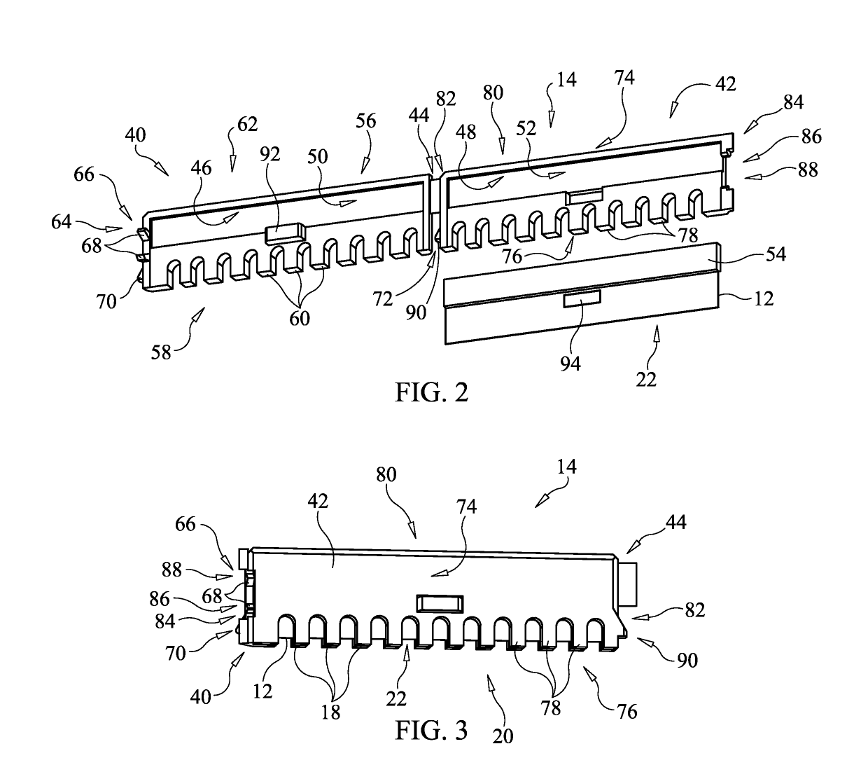

Turning now to FIG. 2, the blade guard 14 of the razor comb hair tool 10 is shown in an open position, with the razor blade 12, which may or may not be a standard straight razor blade, removed from the blade guard 14. The exemplary blade guard 14 includes a first half 40 and a second half 42 joined by, and foldable relative to, a living hinge 44. Thus, the blade guard 14 may be made from a material, such as a polymer, consistent with the formation of the living hinge 44. Each half 40, 42 may include an inner surface 46, 48, respectively, defining a recess, or cavity, 50, 52 for receiving a flange, or handle, 54 of the razor blade 12. Thus, in the open position of the blade guard 14, the razor blade 12 may be positioned relative to one of the first and second halves 40 and 42 of the blade guard 14 such that the flange 54 is received within the respective recess 50 or 52. After the razor blade 12 is so positioned, the first and second halves 40 and 42 may be brought together, by folding one or both of the halves 40 and 42 together about the living hinge 44.

The halves 40 and 42 of the blade guard 14 may be complementary to one another, and may fold together to form a generally rectangular shape. The first half 40 may include the inner surface 46, which includes the recess 50 for receiving portions of the flange 54 of the razor blade 12, and an outer surface 56. The first half 40 also includes a first edge 58, defining first halves 60 of the plurality of spaced apart teeth 18 (shown in FIG. 1), and a second edge 62, which may be received within the retainer 16. A first side 64 of the first half 40 may include a fastening feature 66, which, when mated with a corresponding feature of the second half 42, maintains a closed position of the blade guard 14. According to the exemplary embodiment, the fastening feature 66 may include a pair of flexible protrusions 68 projecting from the inner surface 44. The first side 64 may also include a ramped protrusion 70 extending from the first side 64 and used to secure the blade guard 14 relative to the retainer 16. A second side 72 of the first half 40 may include, attach to, or define, portions of the living hinge 44.

The second half 42 may also include the inner surface 48, which includes the recess 52 for receiving the flange 54 of the razor blade 12, and an outer surface 74. As should be appreciated, only one of the first and second halves 40 and 42 may have features for retaining the razor blade 12 and/or may include alternative means for retaining the razor blade 12. The second half 42 also includes a first edge 76, defining second halves 78 of the plurality of spaced apart teeth 18 (shown in FIG. 1), and a second edge 80, which may be received within the retainer 16. The first and second halves 60 and 78 of the plurality of spaced apart teeth 18 have similar, or nearly identical, profiles such that in the closed position of the blade guard 14 corresponding teeth of the first and second halves 60 and 78 are aligned. A first side 82 of the second half 42 includes, attaches to, or defines, portions of the living hinge 44. A second side 84 of the second half 42 includes a fastening feature 86, such as an opening 88 shaped and sized to receive and retain the flexible protrusions 68 of the first half 40. The first side 82 may also include a ramped protrusion 90, similar to the ramped protrusion 70 of the first half 40, extending from the first side 82 and used to secure the blade guard 14 relative to the retainer 16.

According to some embodiments, and as shown, the inner surface 46 of the first half 40 may include a post 92 configured for receipt within or through a receiver 94 of the razor blade 12. The post 92 and receiver 94 may be incorporated into the design of the razor comb hair tool 10 in order to ensure proper positioning of the razor blade 12 relative to the blade guard 14. According to such an embodiment, non-standard razor blades, including the receiver 94, may be required for use with the razor comb hair tool 10.

Once the razor blade 12 is positioned relative to, or within, the blade guard 14, the first and second halves 40 and 42 may be folded together about the living hinge 44, and the fastening features 66 and 86 may be engaged to maintain a closed position of the blade guard 14, as shown in FIG. 3. In the closed position, the razor blade 12 is retained, or trapped, within the blade guard 14 and the cutting edge 22 of the razor blade 12 is aligned with and extends between the spaced apart comb teeth 18. The halves 40 and 42 of the blade guard 14 may be sized and shaped to provide a tight fit relative to the razor blade 12 to improve performance of the razor comb hair tool 10. To return the blade guard 14 to the open position of FIG. 2, the flexible protrusions 68 may be moved toward one another such that the protrusions 68 may pass back through the opening 88.

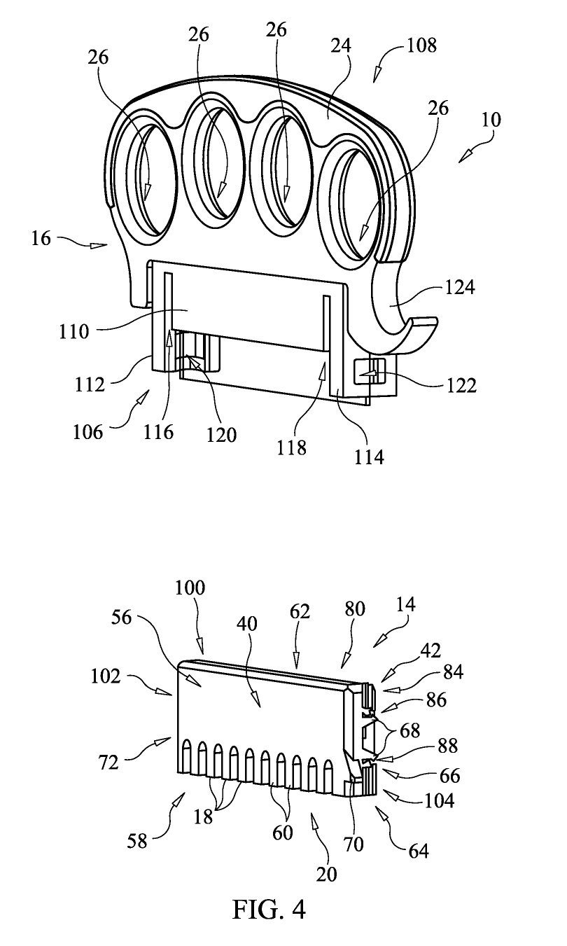

Turning now to FIG. 4, the blade guard 14 is shown in the closed position, prior to the blade guard 14 being releasably received within the retainer 16 of the razor comb hair tool 10 to define the assembled configuration of FIG. 1. In the closed position, the blade guard 14 has the first edge 20 defining the plurality of spaced apart comb teeth 18 and a second edge 100, defined by edges 62 and 80, that may be received within the retainer 16. Opposing sides 102 and 104 of the closed blade guard 14 include the ramped protrusions 70 and 90 introduced above, which may assist in securing the blade guard 14 relative to the retainer 16, as will be described below.

The retainer 16 has first and second opposing ends 106 and 108. The first end 106 of the retainer 16 releasably receives the second edge 100 of the blade guard 14. In particular, the first end 106 includes a housing 110 defined in part by a pair of flexible arms 112 and 114, with flexibility added by slots 116 and 118. As the second edge 100 of the blade guard 14 is inserted into the housing 110, the ramped protrusions 70 and 90 outwardly expand the flexible arms 112 and 114 until the protrusions 70 and 90 are received within respective openings 120 and 122 of the flexible arms 112 and 114. To remove the blade guard 14, the flexible arms 112 and 114 may be moved outward such that the protrusions 70 and 90 are removed from the openings 120 and 122 and the blade guard 14 may be pulled, or removed, from the retainer 16.

The second end 108 of the retainer 16, which may or may not be integral with the first end 106, defines the handle portion 24 of the razor comb hair tool 10 and includes the plurality of curved finger receiving contours 26. The curved finger receiving contours 26 may be closed finger openings, as shown, or may not be completely closed. The handle portion 24 is positioned opposite the comb teeth 18 and razor blade cutting edge 22, as mentioned above, and may include a hair separating feature 124, such as a curved protrusion, used to part hair. Various configurations for the handle portion 24 are contemplated. Although any number and/or shape of finger receiving openings or spaces, which are used to facilitate grasping, use, and manipulation of the razor comb hair tool 10, are contemplated with respect to the handle portion 24, only three additional examples are shown.

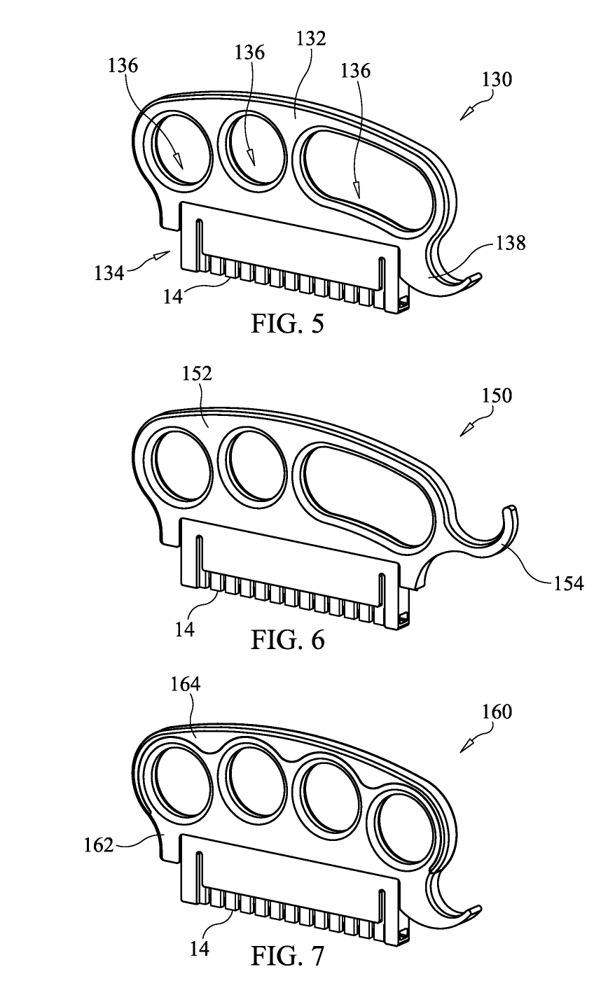

Turning now to FIG. 5, a retainer 130 having an alternative handle portion 132 is shown. A first end 134 of the retainer 130 is similar to the first end 106 of the retainer 16 discussed above and reveals the blade guard 14 described above releasably received within the retainer 130. The handle portion 132 may include three curved finger receiving contours 136 and a hair separating feature 138. The curved finger receiving contours 136 may be defined by portions of enclosed openings (as shown), although it is not necessary. As presented, the curved finger receiving contours 136 may or may not have similar shapes and sizes. Turning now to FIG. 6, a retainer 150 having another alternative handle portion 152 is shown. According to the embodiment of FIG. 6, a hair separating feature 154 may have an alternative positioning relative to the previous embodiments. As shown in FIG. 7, a handle portion 160 of an alternative retainer 162 may include a grip portion 164, made from a softer material than a remaining portion of the handle 160 to provide a comfortable, tactile, and precise grip. Any of the embodiments may incorporate ring inserts, as are known to those skilled in the art, for reducing the finger opening sizes and properly centering a user's fingers within the openings.

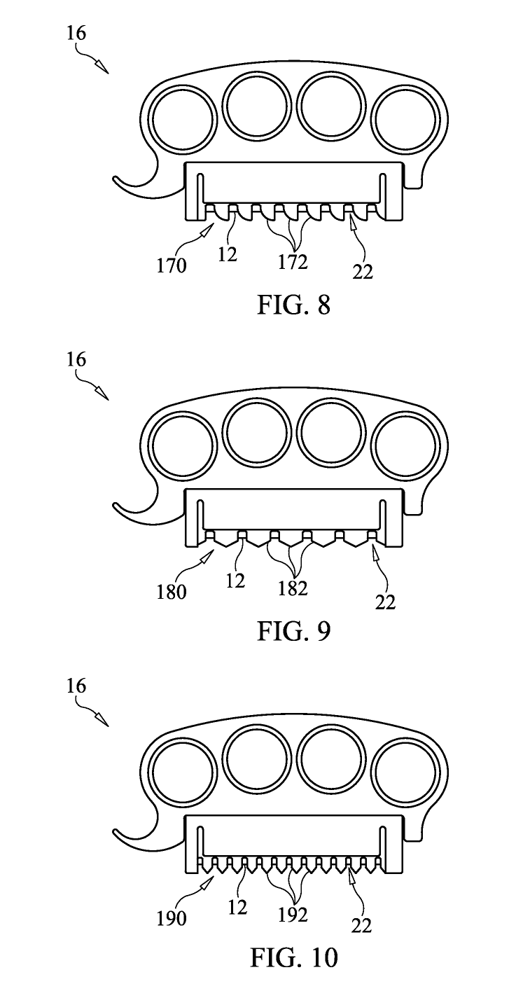

Just as various retainers 16, 130, 150, and 162 may be used with a single blade guard, such as the blade guard 14 described herein, the retainer 16 of FIGS. 1 and 4 may be used with a variety of different blade guard configurations. For example, as shown in FIG. 8, an alternative blade guard 170 may be releasably received within the retainer 16 in a manner similar to that described above. The alternative blade guard 170 may include a first alternative set of comb teeth 172. The cutting edge 22 of the razor blade 12 may be aligned with and may extend between the spaced apart comb teeth 172. FIG. 9 depicts another alternative blade guard 180 having a second alternative set of comb teeth 182, and FIG. 10 depicts yet another alternative blade guard 190 having a third alternative set of comb teeth 192.

The shape, size, spacing between, and configuration of comb teeth 18, 72, 82, and 92 may be selected to provide desired exposure of the cutting edge 22 of the razor blade 12 and, thus, desired performance of the razor comb hair tool 10. For example, the spacing, size, and shape of teeth 192 of FIG. 10 may provide thinning and blending, while the spacing, size, and teeth 182 of FIG. 9 may provide choppy, edgy, or blunt texture. The curved teeth 172 of FIG. 8 may create a softer looking texture. Various alternative embodiments are also contemplated in addition to alternative blade guards 170, 180, and 190.

The razor comb hair tool 10 of the present disclosure may be provided as a kit, including one or more retainers, such as retainers 16, 130, 150, and 162, one or more blade guards, such as blade guards 14, 170, 180, and 190, and one or more standard disposable razor blades, such as razor blade 12. For example, the kit may include at least a razor blade 12, a set of blade guards 14, 170, 180, and 190 (each having a different teeth profile), and a retainer (such as one of retainers 16, 130, 150, and 162). Alternative kits may also include alternative retainers and/or replacement razor blades.

The razor blade 12 may be more quickly, easily, and safely inserted into and removed from the razor comb hair tool 10 than in conventional razor combs. That is, the blade guards 14, 170, 180, and 190 of the razor comb hair tool 10 may include complementary halves that close around the razor blade 12 using a living hinge 44 to secure the razor blade 12 therein. Razor blade replacement and cleaning of the blade guard 14, 170, 180, and 190 are both improved by this configuration, contributing to an improved ability to sanitize, sterilize, and reuse the razor comb hair tool 10.

The assembled blade guard 14, 170, 180, 190 may then be inserted into the retainer 16, 130, 150, 162 and releasably engaged therein. By positioning the handle 24, 132, 152, 160 in close proximity to and on an opposite side of the razor comb hair tool 10 relative to the plurality of comb teeth 18, 172, 182, 192, more precise control is provided for the user. In particular, the razor comb hair tool 10 is held in close proximity to a user's palm, with the ends of the fingers remaining free, to provide precise control by the use of the tool 10 and enabling full hand functionality. The design of the razor comb hair tool 10 disclosed herein permits ambidextrous use, is more ergonomic than conventional designs, and may be readily differentiated from standard combs.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A razor comb hair tool, comprising:
a razor blade;
a blade guard having first and second opposing edges, wherein the first edge of the blade guard defines a plurality of spaced apart comb teeth, the blade guard having a position in which the razor blade is retained within the blade guard and a cutting edge of the razor blade is aligned with and extends between the spaced apart comb teeth; and
a retainer having first and second opposing ends, wherein the first end of the retainer releasably receives the second edge of the blade guard and the second end of the retainer includes a plurality of curved finger receiving contours.

2. The razor comb hair tool of claim 1, wherein the blade guard includes a first half and a second half foldable about a living hinge between open and closed positions.

3. The razor comb hair tool of claim 2, wherein the first and second halves of the blade guard have similar profiles such that, in the closed position of the blade guard, corresponding teeth of the first and second halves are aligned.

4. The razor comb hair tool of claim 2, wherein a first side of the first half of the blade guard may include a fastening feature, which, when mated with a corresponding feature of the second half of the blade guard, maintains a closed position of the blade guard.

5. The razor comb hair tool of claim 2, wherein the spaced apart comb teeth are evenly spaced along the first edge of the blade guard.

6. The razor comb hair tool of claim 2, wherein at least one of the first half and the second half includes a recess for receiving a handle of the razor blade.

7. The razor comb hair tool of claim 6, wherein, in the closed position of the blade guard, the cutting edge is recessed relative to free tips of the spaced apart comb teeth.

8. The razor comb hair tool of claim 1, wherein at least one side of the blade guard includes a ramped protrusion receivable within an opening of the retainer for securing the blade guard relative to the retainer.

9. The razor comb hair tool of claim 1, wherein the curved finger receiving contours define closed finger openings.

10. The razor comb hair tool of claim 8, wherein the retainer also includes a hair separating feature.

11. A razor comb hair tool kit, comprising:
a razor blade;
a set of blade guards, wherein each blade guard has a first edge defining a plurality of spaced apart comb teeth, the blade guard having a position in which the razor blade is retained within the blade guard and a cutting edge of the razor blade is aligned with and extends between the spaced apart comb teeth, wherein a profile of the spaced apart comb teeth of each blade guard in the set is different; and
a first retainer having first and second opposing ends, wherein the first end of the retainer releasably receives a second edge of one of the blade guards and the second end of the retainer includes a plurality of curved finger receiving contours.

12. The razor comb hair tool kit of claim 11, wherein the first edge of each blade guard is opposite the second edge.

13. The razor comb hair tool kit of claim 12, wherein each blade guard includes a first half and a second half foldable about a living hinge between open and closed positions.

14. The razor comb hair tool kit of claim 11, wherein the curved finger receiving contours define closed finger openings.

15. The razor comb hair tool kit of claim 14, further including an alternative retainer having a different number, shape, or location of curved finger receiving contours than the first retainer.

16. The razor comb hair tool kit of claim 11, wherein the first retainer also includes a hair separating feature.

17. The razor comb hair tool kit of claim 11, further including a set of replacement razor blades.
